(19) United States
(12) Patent Application Publication
(10) Pub. No.: US 2010/0090372 A1
(43) Pub. Date: Apr. 15, 2010

(54) COATING FORMATION AGENT FOR PATTERN MICRO-FABRICATION, AND MICROPATTERN FORMATION METHOD USING THE SAME

(75) Inventors: Kiyoshi Ishikawa, Kanagawa (JP); Atsushi Sawano, Kanagawa (JP); Kazumasa Wakiya, Kanagawa (JP)

Correspondence Address: WENDEROTH, LIND & PONACK, L.L.P., 1030 15th Street, N.W.,, Suite 400 East, Washington, DC, 20005-1503, US

(73) Assignee: TOKYO OHKA KOGYO CO., LTD.

(21) Appl. No.: 12/449,024

(22) PCT Filed: Nov. 19, 2007
(86) PCT No.: PCT/JP2007/072364

§ 371 Date: Jul. 21, 2009

(30) Foreign Application Priority Data
Jan. 23, 2007 (JP) 2007-013101

(51) Int. Cl. B29C 61/02; C09D 133/00; C09D 139/06

(52) U.S. Cl. 264/342 R; 524/96; 524/251

(57) ABSTRACT

Provided are a coating formation agent for pattern micro-fabrication, and a method for forming a micropattern using the same, which enables: suppression and/or control of variation of the micro-fabrication size without being accompanied by defect generation following the micro-fabrication process even in ultramicro-fabrication particularly on the order of no greater than 120 nm, or a micro-fabrication process of a resist pattern with an increased aspect ratio; maintainance of a favorable resist pattern configuration after the micro-fabrication process while keeping the desired micro-fabrication size; and also avoidance of defects resulting from development of bacteria and the like after application of the coating formation agent for pattern micro-fabrication. The coating formation agent for pattern micro-fabrication of the present invention is a coating formation agent used for forming a micropattern by coating on a substrate having a photoresist pattern, the coating formation agent including: as component (a), a water soluble polymer; and, as component (b), at least one selected from quaternary ammonium hydroxide, alicyclic ammonium hydroxide and morpholinium hydroxide.

### TECHNICAL FIELD

The present invention relates to a coating formation agent for pattern micro-fabrication in the technical field of photolithography, and a method for forming a micropattern using the same. More specifically, the present invention relates to a coating formation agent for pattern micro-fabrication, and a method for forming a micropattern using the same, capable of dealing with enhanced integration and miniaturization of semiconductor devices in recent years.

### BACKGROUND ART

In the production of electronic components such as semiconductor devices and liquid crystal devices, photolithographic techniques have been used when a substrate is subjected to an etching treatment, etc. In the photolithographic technique, a coating film (photoresist layer) is formed on a substrate using a so-called photoresist material responsive to actinic radiation, then the photoresist layer is selectively irradiated with the actinic radiation, and thereafter a developing treatment is performed to selectively dissolve and remove the photoresist layer so as to form an image pattern (photoresist pattern). Then, a wiring pattern is formed on the substrate by carrying out an etching process with this photoresist pattern as a protective layer (mask pattern).

With a recent growing tendency to highly integrate and miniaturize semiconductor devices, micro-fabrication in the formation of these photoresist patterns has also advanced, and at present ultra-fine processing for a pattern width of no greater than 100 nm is demanded. In addition, as the actinic ray for use in forming the photoresist patterns, short wavelength actinic ray such as KrF, ArF excimer laser beams, EB, EUV and soft X rays are utilized. Therefore, research and development of photoresist materials as a mask pattern forming material having physical properties corresponding to these actinic ray are performed.

In addition, attempts to achieve ultramicro-fabrication in view of the improvements of such photoresist materials, research and development of techniques have been performed in order for the pattern micro-fabrication to exceed the resolution limit of conventional photoresist materials.

For example, Patent Document 1 (Japanese Unexamined Patent Application Publication No. H5-166717) discloses a method for forming and blanking a pattern which includes: forming and blanking a pattern on a resist for pattern formation coated on a substrate; coating a resist for forming a mix to be mixed with the resist for pattern formation on the entire face of the substrate, followed by baking to form a mixing layer on the side wall over the surface of the resist for pattern formation; removing the unmixed part of the resist for forming a mix to achieve micro-fabrication of the mixing layer dimension. Furthermore, Patent Document 2 (Japanese Unexamined Patent Application Publication No. H5-241348) discloses a method for forming a pattern which includes applying a resist containing a resin that becomes insoluble in the presence of an acid, on a substrate on which a resist pattern containing an acid generator was formed, followed by a heat treatment to allow the acid to be removed from the resist pattern, thereby forming a resist film having a certain thickness around the boundary surface of the resist pattern; developing, and removing the resin part where the acid is not diffused to achieve micro-fabrication with the certain thickness dimension. Additionally, Patent Document 3 (Japanese Unexamined Patent Application Publication No. H10-073927) discloses a method including: covering a resist pattern including an acid generator by a material containing a substance that is crosslinkable in the presence of an acid; subjecting to a heat or exposure treatment to generate an acid in the resist pattern; forming a crosslinked layer of the resist pattern yielded on the boundary surface as a coat layer to result in thickening of the resist pattern, whereby the hole diameter and the width of separation of the resist pattern are decreased.

However, in these methods, since the thermal dependency of a wafer face becomes as large as tens of nm/° C., and since it is very difficult to control uniformly the film thickness of the formed coating film on the resist pattern on the wafer face having a larger diameter, so as to cause a significant problem of resist pattern dimension unevenness after completing the micro-fabrication process. Moreover, it is also difficult to prevent occurrence of the defect (pattern defect) after the micro-fabrication process, and furthermore, a problem of difficulty in a reworking process (process in which the resist pattern itself is removed once from the wafer) may be caused when formation of the resist pattern is restarted.

On the other hand, a method for micro-fabricating a pattern dimension by fluidizing the resist pattern by heat treatment or the like has been also known. For example, in Patent Document 4 (Japanese Unexamined Patent Application Publication No. H1-307228), a method is disclosed for forming a micropattern by forming a resist pattern on a substrate, followed by heat-treatment thereof to deform the cross-sectional shape of the resist pattern. Furthermore, in Patent Document 5 (Japanese Unexamined Patent Application Publication No. H4-364021), a method is disclosed for forming a micropattern by forming a resist pattern, followed by heating to approximately the softening temperature of the resist, so as to alter the pattern dimension by way of fluidization of the resist.

However, in these methods, it is difficult to control the micro-fabrication size by the thermal flow and to obtain a resist pattern after the micro-fabrication process such that a favorable rectangular shape is maintained, and a problem of difficulty in controlling the micro-fabrication size of sparse/dense patterns being present mixed in the wafer to be constant is caused.

As a further developed method based on the methods described above, for example, Patent Document 6 (Japanese Unexamined Patent Application Publication No. H7-45510) discloses a method for forming a micro-fabricated resist pattern which includes: forming a resin film for preventing excessive flow of a resist on a substrate on which the resist pattern is formed; subjecting to a heat treatment to allow the resist to be fluidized, thereby altering the pattern dimension; and thereafter removing the resin.

However, in this method, it is difficult to obtain a resist pattern after the micro-fabrication process such that a favorable rectangular shape is maintained, and a problem of difficulty in controlling the micro-fabrication size of sparse/dense patterns being present mixed in the wafer to be constant and suppressing variation of the micro-fabrication size of the photoresist pattern depending on variation of the heating temperature.

Additionally, the present applicant proposed techniques regarding coating formation agent for pattern micro-fabrication and method for forming a micropattern in Patent Document 7 to 12 (Japanese Unexamined Patent Application Publication Nos. 2003-084459, 2003-084460, 2003-107752, 2003-142381, 2003-195527 and 2003-202679), and the like. With the techniques disclosed in Patent Documents 7 to 12 etc., it has become possible to obtain micropatterns having properties required in semiconductor devices such as improvement of controllability of the pattern dimension, and achievement of a favorable rectangular shape of the resist pattern after the micro-fabrication process.

In the micropattern forming technique using this coating formation agent for pattern micro-fabrication, a photoresist layer is first formed on a substrate, followed by exposing and developing the same to form a photoresist pattern. Then, after a coating formation agent for pattern micro-fabrication is coated over the entire surface of the substrate, the coated substrate is heated so as to widen the photoresist pattern in width utilizing the action of shrinkage by heat of the coating formation agent for pattern micro-fabrication. As a result, the intervals of photoresist pattern are narrowed, and the widths of patterns defined by intervals of photoresist patterns are also narrowed, thereby obtaining a fine pattern.

More specifically, controllability of the resist pattern dimension is affected in two steps of the photoresist pattern formation step (first step), and the thermal shrinkage of the coating formation agent for pattern micro-fabrication (second step) according to the pattern micro-fabrication described above. In forming the resist pattern using such a procedure, it is necessary to allow the resist pattern configuration formed in the first step to be shrinked in the second step, the thermal shrinkage step, while keeping the configuration at a constant thermal shrinkage rate.

However, in the ultramicro-fabrication to give a pattern dimension on the order of no greater than 100 nm, or in the micro-fabrication process of the resist pattern with an increased aspect ratio, more strict control of the resist pattern configuration after the micro-fabrication process, and more strict regulation of the micro-fabrication size are desired. Under such circumstances, even if a micropattern formation technique using such a coating formation agent for pattern micro-fabrication is employed, deterioration of the configuration such as slight rounding of the top and bottom shapes of the resist patter after the micro-fabrication process may be caused. In addition, problems such as variation of the heating temperature in the wafer face may cause problems such as variation of the micro-fabrication size, and variation of the micro-fabrication size of the sparse/dense patterns being present mixed in the wafer face, which cannot be controlled properly on the nanometer order. The present invention was made in order to solve the foregoing problems.

Patent Document 13 (Japanese Unexamined Patent Application Publication No. 2001-281886) discloses a method for reducing the dimension of a resist pattern by coating an acidic film which includes a resist pattern miniaturizing material containing a water soluble resin on a resist pattern surface, followed by conversion of the resist pattern surface layer into alkali-soluble, and then removing the surface layer and the acidic coating film with an alkaline solution. Furthermore, Patent Document 14 (Japanese Unexamined Patent Application Publication No. 2002-184673) discloses a method for forming a micro-fabricated resist pattern without need of a dry etching step, the method including forming a resist pattern on a substrate, forming a coating film containing a water soluble film forming component on the resist pattern, subjecting these resist patterns and the coating film to a heat treatment, and thereafter immersing in an aqueous tetramethylammonium hydroxide solution. However, any of these is a method of micro-fabrication of a resist pattern itself, and thus the object thereof completely different from that of the present invention is intended.

Patent Document 1: Japanese Unexamined Patent Application Publication No. H5-166717

Patent Document 2: Japanese Unexamined Patent Application Publication No. H5-241348

Patent Document 3: Japanese Unexamined Patent Application Publication No. H10-073927

Patent Document 4: Japanese Unexamined Patent Application Publication No. H1-307228

Patent Document 5: Japanese Unexamined Patent Application Publication No. H4-364021

Patent Document 6: Japanese Unexamined Patent Application Publication No. H7-45510

Patent Document 7: Japanese Unexamined Patent Application Publication No. 2003-084459

Patent Document 8: Japanese Unexamined Patent Application Publication No. 2003-084460

Patent Document 9: Japanese Unexamined Patent Application Publication No. 2003-107752

Patent Document 10: Japanese Unexamined Patent Application Publication No. 2003-142381

Patent Document 11: Japanese Unexamined Patent Application Publication No. 2003-195527

Patent Document 12: Japanese Unexamined Patent Application Publication No. 2003-202679

Patent Document 13: Japanese Unexamined Patent Application Publication No. 2001-281886

Patent Document 14: Japanese Unexamined Patent Application Publication No. 2002-184673

### DISCLOSURE OF THE INVENTION

### Problems to be Solved by the Invention

The present invention was made in view of the circumstances described above, and an object of the invention is to provide a coating formation agent for pattern micro-fabrication, and a method for forming a micropattern using the same, which enables: suppression and/or control of variation of the micro-fabrication size without being accompanied by defect generation following the micro-fabrication process even in ultramicro-fabrication particularly on the order of no greater than 120 nm, or a micro-fabrication process of a resist pattern with an increased aspect ratio; maintainance of a favorable resist pattern configuration after the micro-fabrication process while keeping the desired micro-fabrication size; and also avoidance of defects resulting from development of bacteria and the like after application of a coating formation agent for pattern micro-fabrication.

### Means for Solving the Problems

In order to solve the problems described above, the present invention provides a coating formation agent for pattern micro-fabrication used for forming a micropattern by coating on a substrate having a photoresist pattern, the coating formation agent including: as component (a), a water soluble polymer; and, as component (b), at least one selected from quaternary ammonium hydroxide, alicyclic ammonium hydroxide and morpholinium hydroxide.

In addition, the present invention provides a method for forming a micropattern which includes steps of: applying the coating formation agent for pattern micro-fabrication on a substrate having a photoresist pattern; thereafter allowing the coating formation agent for pattern micro-fabrication to be thermally shrinked by a heating treatment; and then removing the coating formation agent for pattern micro-fabrication.

### EFFECTS OF THE INVENTION

According to the techniques which include providing a coating film constituted with a coating formation agent for pattern micro-fabrication on a substrate having a photoresist pattern to form a micropattern, to suppress and/or control the variation of the micro-fabrication size which may result from variation of the heating treatment temperature of the wafer face, or the presence of the sparse/dense pattern admixed on the wafer face as well as from differences among manufacturing lots or differences among manufacturing date is enabled without being accompanied by defect generation following the micro-fabrication process even in ultramicro-fabrication particularly on the order of no greater than 120 nm, or a micro-fabrication process of a resist pattern with an increased aspect ratio. Furthermore, it is possible to keep and control favorably the resist pattern configuration after the micro-fabrication process while maintaining the desired micro-fabrication size. Moreover, defects due to development of bacteria and the like on the wafer face after applying the coating formation agent can be also eliminated.

### PREFERRED MODE FOR CARRYING OUT THE INVENTION

### Coating Formation Agent for Pattern Micro-Fabrication

The coating formation agent for pattern micro-fabrication of the present invention (hereinafter, merely referred to as “coating formation agent”) is constituted with an aqueous solution containing: as component (a), a water soluble polymer; and as component (b), at least one selected from quaternary ammonium hydroxide, alicyclic ammonium hydroxide and morpholinium hydroxide.

### (a) Water Soluble Polymer

The water soluble polymer as the component (a) is not particularly limited so long as it is a polymer which is water-soluble at room temperature. In the present invention, for example, a polymer or a copolymer, or a mixture of these (co)polymers constituted with at least one monomer selected from acrylic acid, methyl acrylate, methacrylic acid, N,N-dimethylacrylamide, N,N-dimethylaminopropylmethacrylamide, N,N-dimethylaminopropylacrylamide, N-methylacrylamide, diacetoneacrylamide, N,N-dimethylaminoethyl methacrylate, N,N-diethylaminoethyl methacrylate, N,N-dimethylaminoethyl acrylate, N-acryloylmorpholine, N-vinylpyrrolidone, vinyl acetate, and N-vinylimidazolidinone can be used.

In addition, as a cellulose based resin, for example, hydroxypropyl methylcellulose phthalate, hydroxypropyl methylcellulose acetatephthalate, hydroxypropyl methylcellulose hexahydrophthalate, hydroxypropyl methylcellulose acetate succinate, hydroxypropyl methylcellulose, hydroxypropyl cellulose, hydroxyethyl cellulose, cellulose acetate hexahydrophthalate, carboxymethyl cellulose, ethyl cellulose, methyl cellulose and the like can be used in the present invention.

Among them, the component (a) used in the present invention is preferably a polymer and/or a copolymer of at least one monomer selected from N-vinylpyrrolidone and vinyl alcohol, and particularly preferably a polymer of polyvinylpyrrolidone.

Furthermore, the mass-average molecular weight of such a component (a) is preferably 50,000 to 300,000.

When a coating film is provided on the resist pattern, the amount of the component (a) included according to the present invention is adjusted appropriately in a range which enables the provision of a film thickness that is necessary and sufficient for use, and the amount is preferably about 1 to 99% by mass, more preferably about 40 to 99% by mass, and still more preferably about 65 to 99% by mass in the total solid content of the coating formation agent.

(b) At Least One Selected from Quaternary Ammonium Hydroxide, Alicyclic Ammonium Hydroxide and Morpholinium Hydroxide

The at least one selected from quaternary ammonium hydroxide, alicyclic ammonium hydroxide and morpholinium hydroxide as the component (b) may include, for example, the following compounds.

The quaternary ammonium hydroxide may include the quaternary ammonium hydroxide represented by the following general formula (b1).

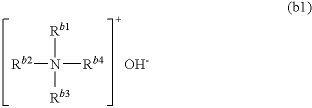

In the above general formula (b1), R^{b1}, R^{b2}, R^{b3}, R^{b4} each independently represent an alkyl group or a hydroxyalkyl group having 1 to 4 carbon atoms.

Specific examples of the quaternary ammonium hydroxide represented by the general formula (b1) include tetramethylammonium hydroxide (TMAH), tetraethylammonium hydroxide, tetrapropylammonium hydroxide, tetrabutylammonium hydroxide, methyltripropylammonium hydroxide, methyltributylammonium hydroxide, trimethylethylammonium hydroxide, (2-hydroxyethyl)trimethylammonium hydroxide (choline), (2-hydroxyethyl)triethylammonium hydroxide, (2-hydroxyethyl)tripropylammonium hydroxide, (1-hydroxypropyl)trimethylammonium hydroxide, and the like.

Moreover, the alicyclic ammonium hydroxide may include the alicyclic ammonium hydroxide represented by the following general formulae (b2) and (b3).

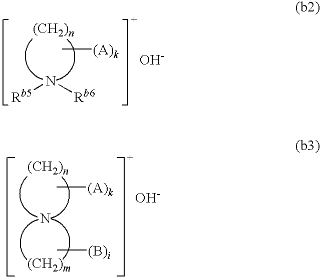

In the above general formulae (b2) and (b3), A and B represent an alkyl group having 1 to 6 carbon atoms, k and i each represent an integer of 0 to 4, n and m each represent an integer of 3 to 7, R^{b5} and R^{b6} each represent an alkyl group having 1 to 8 carbon atoms.

Specific examples of the cation of the alicyclic ammonium hydroxide represented by the general formulae (b2) and (b3) include N,N-dimethylpyrrolidinium ion, N,N-diethylpyrrolidinium ion, N,N-di-n-propylpyrrolidinium ion, N,N-di-n-butylpyrrolidinium ion, N,N-dimethylpiperidinium ion, N,N-diethylpiperidinium ion, N,N-di-n-propylpiperidinium ion, N,N-di-n-butylpiperidinium ion, spiro-(1,1′)-biazacyclobutyl ion, azacyclopentane-1-spiro-1′-azacyclobutyl ion, azacyclohexane-1-spiro-1′-azacyclobutyl ion, azacycloheptane-1-spiro-1′-azacyclobutyl ion, azacyclooctane-1-spiro-1′-azacyclobutyl ion, spiro-(1,1′)-biazacyclopentyl ion, azacyclohexane-1-spiro-1′-azacyclopentyl ion, azacycloheptane-1-spiro-1′-azacyclopentyl ion, azacyclooctane-1-spiro-1′-azacyclopentyl ion, spiro-(1,1′)-biazacyclohexyl ion, azacycloheptane-1-spiro-1′-azacyclohexyl ion, azacyclooctane-1-spiro-1′-azacyclohexyl ion, spiro-(1,1′)-biazacycloheptyl ion, azacyclooctane-1-spiro-1′-azacycloheptyl ion, and spiro-(1,1′)-biazacyclooctyl ion.

Furthermore, the morpholinium hydroxide may include the morpholinium ammonium hydroxide represented by the following general formulae (b4) and (b5).

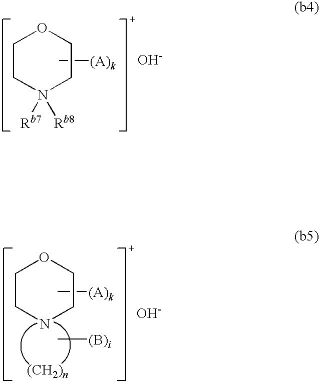

In the above general formulae (b4) and (b5), A and B represent an alkyl group having 1 to 6 carbon atoms, k and i represent an integer of 0 to 4, n represent an integer of 3 to 7, R^{b7} and R^{b8} represent an alkyl group having 1 to 8 carbon atoms.

Examples of the cation of such morpholinium hydroxide represented by the general formulae (b4) and (b5) include N,N-dimethyl morpholinium ion, N,N-diethyl morpholinium ion, N,N-dipropyl morpholinium ion, N,N-dibutyl morpholinium ion, N,N-dipentyl morpholinium ion, N,N-diheptyl morpholinium ion, N,N-dioctyl morpholinium ion, N,N-ethylmethyl morpholinium ion, N,N-propylmethyl morpholinium ion, morpholine-4-spiro-1′-azacyclobutyl ion, morpholine-4-spiro-1′-azacyclopentyl ion, morpholine-4-spiro-1′-azacyclohexyl ion, morpholine-4-spiro-1′-azacycloheptyl ion, and morpholine-4-spiro-1′-azacyclooctyl ion.

Among the hydroxides described above, the quaternary ammonium hydroxide is preferred, and at least one selected from among tetramethylammonium hydroxide, tetrabutylammonium hydroxide, tetrapropylammonium hydroxide, methyltributylammonium hydroxide, methyltripropylammonium hydroxide, and choline is particularly preferred.

The component (b) as described above is blended in an amount of preferably 0.001 to 3 parts by mass, and particularly preferably 0.01 to 1 part by mass based on 100 parts by mass of the aforementioned component (a).

The coating formation agent of the present invention is usually used in the form of an aqueous solution that contains the component (a) and the component (b) described above. This coating formation agent is preferably used with a concentration of the solid content being 3 to 50% by mass, and more preferably used in the form of an aqueous solution having a concentration of 5 to 20% by mass.

Although the coating formation agent is preferably used in the form of the aqueous solution, it may be provided in a mixed solvent of water and an alcoholic solvent as long as the effects of the present invention are not impaired. Examples of the alcoholic solvent include methyl alcohol, ethyl alcohol, propyl alcohol, isopropyl alcohol, glycerin, ethylene glycol, propylene glycol, 1,2-butylene glycol, 1,3-butylene glycol, 2,3-butylene glycol, and the like. These alcoholic solvents may be used as a mixture in a proportion up to 30% by mass based on 100 parts by mass of water.

Since the coating formation agent of the present invention contains the component (a) and the component (b) as described above, to suppress and/or control the variation of the micro-fabrication size which may result from variation of the heating treatment temperature of the wafer face, or the presence of the sparse/dense pattern admixed on the wafer face as well as from differences among manufacturing lots or differences among manufacturing date is enabled without being accompanied by defect generation following the micro-fabrication process even in ultramicro-fabrication particularly on the order of no greater than 120 nm, or a micro-fabrication process of a resist pattern with an increased aspect ratio. In addition, it is possible to keep and control favorably the resist pattern configuration after the micro-fabrication process while maintaining the desired micro-fabrication size. Moreover, defects due to development of bacteria and the like on the wafer face after applying the coating formation agent can be also eliminated.

Additionally, the following water soluble crosslinking agent, surfactant, water soluble fluorine compound, amide group-containing monomer, heterocyclic compound having at least an oxygen atom and/or nitrogen atom, heterocyclic compound having two or more nitrogen atoms in at least the same ring, water soluble amine compound, non-amine based water soluble organic solvent and the like may be blended in the coating formation agent according to the present invention as needed in the range not to impair the effects of the present invention. Examples of such components which may be added appropriately include those described below.

### Water Soluble Crosslinking Agent

As the water soluble crosslinking agent, a nitrogen-containing compound having an amino group and/or imino group in which at least two hydrogen atoms are substituted with a hydroxyalkyl group and/or alkoxyalkyl group is preferably used. Examples of such nitrogen-containing compounds include melamine based derivatives, urea based derivatives, guanamine based derivatives, acetoguanamine based derivatives, benzoguanamine based derivatives and succinyl amide based derivatives in which the hydrogen atom of the amino group is substituted with a methylol group or an alkoxymethyl group or both of these, as well as glycoluril based derivatives and ethylene urea based derivatives in which the hydrogen atom of the imino group is substituted, and the like.

Among these nitrogen-containing compounds, at least one or more of: triazine derivatives such as benzoguanamine based derivatives, guanamine based derivatives, and melamine based derivatives, glycoluril based derivatives, and urea based derivatives, which have an amino group and/or an imino group in which at least two hydrogen atoms are substituted with a methylol group or a lower alkoxymethyl group having 1 to 6 carbon atoms, or both of these, are preferred in light of the crosslinking reactivity.

The amount of such a water soluble crosslinking agent when added is preferably adjusted to 1 to 35% by mass in the solid content of the coating formation agent.

### Surfactant

Characteristics such as high solubility in the aforementioned water soluble polymer (a), and preclusion of development of suspension, and the like are required for the surfactant. Use of such a surfactant that complies with these characteristics can suppress generation of air bubble (microfoam), especially when applying the coating formation agent, thereby enabling more effective prevention of defect generation reportedly related to the microfoam generation. In view of the foregoing aspects, one or more of an N-alkylpyrrolidone based surfactant, a quaternary ammonium salt based surfactant, a surfactant based on a phosphoric acid ester of polyoxyethylene, and a nonionic surfactant may be preferably used.

As the N-alkylpyrrolidone based surfactant, a compound represented by the following general formula (1) is preferred.

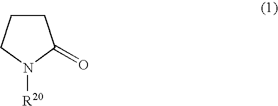

In the above general formula (1), R²⁰ represents an alkyl group having 6 or more carbon atoms.

Specific examples of such an N-alkylpyrrolidone based surfactant include N-hexyl-2-pyrrolidone, N-heptyl-2-pyrrolidone, N-octyl-2-pyrrolidone, N-nonyl-2-pyrrolidone, N-decyl-2-pyrrolidone, N-decyl-2-pyrrolidone, N-undecyl-2-pyrrolidone, N-dodecyl-2-pyrrolidone, N-tridecyl-2-pyrrolidone, N-tetradecyl-2-pyrrolidone, N-pentadecyl-2-pyrrolidone, N-hexadecyl-2-pyrrolidone, N-heptadecyl-2-pyrrolidone, N-octadecyl-2-pyrrolidone, and the like. Among these, N-octyl-2-pyrrolidone (“SURFADONE LP 100”; manufactured by ISP) is preferably used.

As the quaternary ammonium based surfactant, a compound represented by the following general formula (2) is preferred.

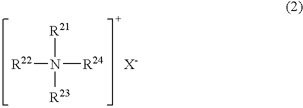

In the above general formula (2), R²¹, R²², R²³ and R²⁴ each independently represent an alkyl group or a hydroxyalkyl group (wherein, at least one of thereof represents an alkyl group or a hydroxyalkyl group having 6 or more carbon atoms), and X⁻ represents a hydroxide ion or a halogen ion.

Specifically, such quaternary ammonium surfactants include dodecyltrimethylammonium hydroxide, tridecyltrimethylammonium hydroxide, tetradecyltrimethylammonium hydroxide, pentadecyltrimethylammonium hydroxide, hexadecyltrimethylammonium hydroxide, heptadecyltrimethylammonium hydroxide, octadecyltrimethylammonium hydroxide, and the like. Among these, hexadecyltrimethylammonium hydroxide is preferably used.

As the aforementioned surfactant based on a phosphoric acid ester of polyoxyethylene, a compound represented by the following general formula (3) is preferred.

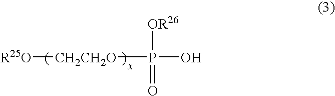

In the above general formula (3), R²⁵ represents an alkyl group or an alkylallyl group having 1 to 10 carbon atoms, R²⁶ represents a hydrogen atom or (CH₂CH₂O)R²⁵ (wherein R²⁵ is as defined above), and x represents an integer of 1 to 20.

Specifically, as such a surfactant based on a phosphoric acid ester of polyoxyethylene, commercially available products such as “Plysurf A212E” and “Plysurf A210G” (both manufactured by Dai-ichi Kogyo Seiyaku Co., Ltd.) can be preferably used.

The nonionic surfactant is preferably an alkyl etherified product of polyoxyalkylene, or an alkylamine oxide compound.

As the alkyl etherified product of polyoxyalkylene, a compound represented by the following general formula (4) or (5) is preferably used.

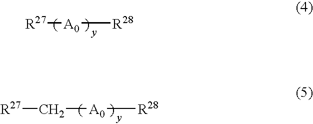

In the above general formulae (4) and (5), R²⁷ and R²⁸ represent a linear, branched or cyclic alkyl group, an alkyl group having a hydroxyl group, or an alkylphenyl group having 1 to 22 carbon atoms. A₀ represents an oxyalkylene group, and is preferably at least one selected from oxyethylene, oxypropylene, and oxybutylene groups. The symbol y represents an integer.

As the alkylamine oxide compound, a compound represented by the following general formula (6) or (7) is preferably used.

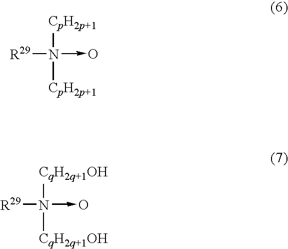

In the above general formulae (6) and (7), R²⁹ represents an alkyl group or a hydroxyalkyl group having 8 to 20 carbon atoms which may be interrupted with an oxygen atom, and p and q represent an integer of 1 to 5.

Examples of the alkylamine oxide compound represented by the above general formulae (6) and (7) include octyldimethylamine oxide, dodecyldimethylamine oxide, decyldimethylamine oxide, lauryldimethylamine oxide, cetyldimethylamine oxide, stearyldimethylamine oxide, isohexyldiethylamine oxide, nonyldiethylamine oxide, lauryldiethylamine oxide, isopentadecylmethylethylamine oxide, stearylmethylpropylamine oxide, lauryldi(hydroxyethyl)amine oxide, cetyldiethanolamine oxide, stearyldi(hydroxyethyl)amine oxide, dodecyloxyethoxyethoxyethyldi(methyl)amine oxide, stearyloxyethyldi(methyl)amine oxide, and the like.

Among these surfactants, a nonionic surfactant is preferably used in light of reduction of defects, in particular.

The amount of the surfactant when added is preferably about 1 ppm to 10% by mass, and more preferably about 100 ppm to 2% by mass in the solid content of the coating formation agent.

### Water Soluble Fluorine Compound

It is necessary that the water soluble fluorine compound has characteristics such as high solubility in the aforementioned water soluble polymer (a), and preclusion of development of suspension, and the like. Use of a water soluble fluorine compound that complies with such characteristics can improve a leveling property (extent of spreading of the coating formation agent). Although this leveling property can be achieved by lowering of the contact angle by adding a surfactant, when the amount of addition of the surfactant is in excess, further improvement in application at a certain level or higher cannot be achieved, but by adding in an excess amount, the bubble (microfoam) may be generated on the coating film, thereby leading to a problem of potentially causing defects. By blending this water soluble fluorine compound, the contact angle is lowered while suppressing such foaming, and thus leveling properties can be improved.

As the water soluble fluorine compound, fluoroalkyl alcohols, fluoroalkylcarboxylic acids and the like are preferably used. Examples of the fluoroalkyl alcohols include 2-fluoro-1-ethanol, 2,2-difluoro-1-ethanol, trifluoroethanol, tetrafluoropropanol, octafluoroamyl alcohol, and the like. Examples of the fluoroalkylcarboxylic acids include trifluoroacetic acid, and the like. However, the fluoroalkylcarboxylic acid is not limited to such exemplified compounds, and is acceptable as long as it is a fluorine compound having water solubility, and exhibits the effects described above. In particular, fluoroalkyl alcohols having 6 or less carbon atoms may be preferably used. Among these, in light of ready availability and the like, trifluoroethanol is particularly preferred.

The amount of the water soluble fluorine compound when added is adjusted to preferably about 0.1 to 30% by mass, and more preferably about 0.1 to 15% by mass in the solid content of coating formation agent.

### Amide Group-Containing Monomer

Although the amide group-containing monomer is not particularly limited, characteristics such as high solubility in the aforementioned water soluble polymer (a), and preclusion of development of suspension, and the like are required.

As the amide group-containing monomer, the amide compound represented by the following general formula (8) is preferably used.

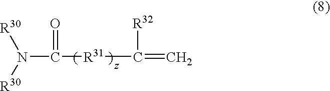

In the above general formula (8), R³⁰ represents a hydrogen atom, an alkyl group or a hydroxyalkyl group having 1 to 5 carbon atoms, R³¹ represents an alkyl group having 1 to 5 carbon atoms, R³² represents a hydrogen atom or a methyl group, and z represent an integer of 0 to 5. In the foregoing, the alkyl group, and the hydroxyalkyl group may be either linear, or branched.

In the above general formula (8), an amide group-containing monomer in which R³⁰ represents a hydrogen atom, a methyl group, or an ethyl group; and z represents 0 is more preferably used. Specific examples of the amide group-containing monomer include acrylamide, methacrylamide, N,N-dimethylacrylamide, N,N-dimethylmethacrylamide, N,N-diethylacrylamide, N,N-diethylmethacrylamide, N-methylacrylamide, N-methylmethacrylamide, N-ethylacrylamide, N-ethylmethacrylamide, and the like. Among these, acrylamide, and methacrylamide are particularly preferred.

The amount of the amide group-containing monomer when added is adjusted to preferably about 0.1 to 30% by mass, and particularly preferably about 1 to 15% by mass in the solid content of the coating formation agent.

Heterocyclic Compound Having at Least Oxygen Atom and/or Nitrogen Atom

A heterocyclic compound having at least an oxygen atom and/or nitrogen atom may be blended. As the heterocyclic compound, at least one selected from a compound having an oxazolidine skeleton, a compound having an oxazoline skeleton, a compound having an oxazolidone skeleton, and a compound having an oxazolidinone skeleton is preferably used.

Examples of the compound having an oxazolidine skeleton include oxazoline represented by the following chemical formula (9), as well as substituted products thereof.

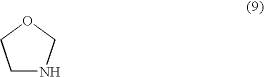

Examples of the substituted product include compounds having substitution of a hydrogen atom bound to the carbon atom or nitrogen atom of oxazoline represented by the above chemical formula (9), with a substituted or unsubstituted lower alkyl group having 1 to 6 carbon atoms, a carboxyl group, a hydroxyl group, or a halogen atom. As the substituted lower alkyl group, a hydroxyalkyl group, a lower alkoxyalkyl group, and the like may be exemplified, but not limited thereto.

Examples of the compound having an oxazoline skeleton include 2-oxazoline represented by the following chemical formula (8-1), 3-oxazoline represented by the chemical formula (8-2), 4-oxazoline represented by the chemical formula (8-3), as well as substituted products thereof.

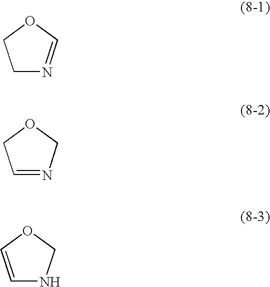

Examples of the substituted product include compounds having substitution of a hydrogen atom bound to the carbon atom or nitrogen atom of a compound having an oxazoline skeleton represented by the above chemical formulae (8-1) to (8-3), with a substituted or unsubstituted lower alkyl group having 1 to 6 carbon atoms, a carboxyl group, a hydroxyl group, or a halogen atom. As the substituted lower alkyl group, a hydroxyalkyl group, a lower alkoxyalkyl group, and the like may be exemplified, but not limited thereto.

Among the compounds having an oxazoline skeleton, 2-methyl-2-oxazoline represented by the following chemical formula (8-1-A) is preferably used.

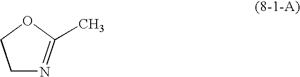

Examples of the compound having an oxazolidone skeleton include 5(4)-oxazolone represented by the following chemical formula (9-1), 5(2)-oxazolone represented by the following chemical formula (9-2), 4(5)-oxazolone represented by the following chemical formula (9-3), 2(5)-oxazolone represented by the following chemical formula (9-4), 2(3)-oxazolone represented by the following chemical formula (9-5), as well as substituted products thereof.

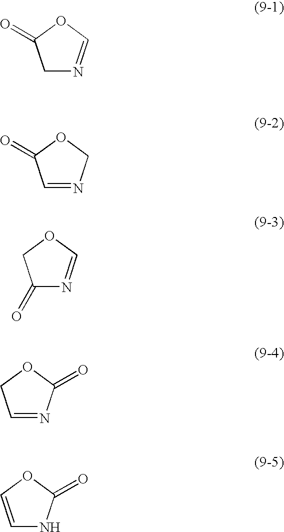

Examples of the substituted product include compounds having substitution of a hydrogen atom bound to the carbon atom or nitrogen atom of a compound having an oxazoline skeleton represented by the above chemical formulae (9-1) to (9-5), with a substituted or unsubstituted lower alkyl group having 1 to 6 carbon atoms, a carboxyl group, a hydroxyl group, or a halogen atom. As the substituted lower alkyl group, a hydroxyalkyl group, a lower alkoxyalkyl group, and the like may be exemplified, but not limited thereto.

Examples of the compound having an oxazolidinone skeleton (or compound having a 2-oxazolidone skeleton) include oxazolidinone (or 2-oxazolidone) represented by the following chemical formula (10), as well as substituted products thereof.

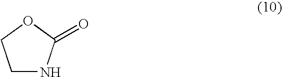

Examples of the substituted product include compounds having substitution of a hydrogen atom bound to the carbon atom or nitrogen atom of oxazolidinone (or 2-oxazolidone) represented by the above chemical formula (10), with a substituted or unsubstituted lower alkyl group having 1 to 6 carbon atoms, a carboxyl group, a hydroxyl group, or a halogen atom. As the substituted lower alkyl group, a hydroxyalkyl group, a (lower alkoxy)alkyl group, and the like may be exemplified, but not limited thereto.

Among the compounds having an oxazolidinone skeleton, 3-methyl-2-oxazolidone represented by the following chemical formula (10-1) is preferably used.

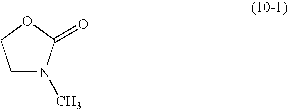

The amount of the heterocyclic compound having at least an oxygen atom and/or nitrogen atom when added is adjusted to preferably about 1 to 50% by mass, and more preferably 3 to 20% by mass based on the mass of the aforementioned water soluble polymer (a).

### Heterocyclic Compound Having Two or More Nitrogen Atoms in at Least the Same Ring

Examples of the heterocyclic compound having two or more nitrogen atoms in at least the same ring include pyrazole based compounds such as pyrazole, 3,5-dimethylpyrazole, 2-pyrazoline, 5-pyrazolone, 3-methyl-1-phenyl-5-pyrazolone, 2,3-dimethyl-1-phenyl-5-pyrazolone, 2,3-dimethyl-4-dimethylamino-1-phenyl-5-pyrazolone, and benzopyrazole; imidazole based compounds such as imidazole, methylimidazole, 2,4,5-triphenylimidazole, 4-(2-aminoethyl)imidazole, and 2-amino-3-(4-imidazolyl)propionic acid; imidazoline based compounds such as 2-imidazoline, 2,4,5-triphenyl-2-imidazoline, and 2-(1-naphthylmethyl)-2-imidazoline; imidazolidine based compounds such as imidazolidine, 2-imidazolidone, 2,4-imidazolidinedione, 1-methyl-2,4-imidazolidinedione, 5-methyl-2,4-imidazolidinedione, 5-hydroxy-2,4-imidazolidinedione-5-carboxylic acid, 5-ureide-2,4-imidazolidinedione, 2-imino-1-methyl-4-imidazolidone, and 2-thioxo-4-imidazolidone; benzoimidazole based compounds such as benzoimidazole, 2-phenylbenzoimidazole, and 2-benzoimidazolinone; diazine based compound such as 1,2-diazine, 1,3-diazine, 1,4-diazine, and 2,5-dimethylpyrazine; hydropyrimidine based compounds such as 2,4(1H, 3H)pyrimidinedione, 5-methyluracil, 5-ethyl-5-phenyl-4,6-perhydropyrimidinedione, 2-thioxo-4(1H, 3H)-pyrimidinone, 4-imino-2(1H, 3H)-pyrimidine, and 2,4,6(1H, 3H, 5H)-pyrimidinetrione; benzodiazine based compounds such as cinnoline, phthalazine, quinazoline, quinoxaline, and luminol; dibenzodiazine based compounds such as benzoshinorine, phenazine, and 5,10-dihydrophenazine; triazole based compounds such as 1H-1,2,3-triazole, 1H-1,2,4-triazole, and 4-amino-1,2,4-triazole; benzotriazole based compounds such as benzotriazole, and 5-methylbenzotriazole; triazine based compounds such as 1,3,5-triazine, 1,3,5-triazine-2,4,6-triol, 2,4,6-trimethoxy-1,3,5-triazine, 1,3,5-triazine-2,4,6-trithiol, 1,3,5-triazine-2,4,6-triamine, and 4,6-diamino-1,3,5-triazine-2-ol, and the like, but not limited thereto.

Among these, in light of ease in handling, ready availability, and the like, a monomer of an imidazole based compound is preferably used, and particularly imidazole is preferably used.

The amount of the heterocyclic compound having two or more nitrogen atoms in at least the same ring when added is adjusted to preferably about 1 to 15% by mass, and more preferably about 2 to 10% by mass based on the mass of the water soluble polymer (a).

### Water Soluble Amine Compound

Use of such a water soluble amine compound enables the prevention of the generation of impurities, and adjustment of the pH, and the like.

Examples of the water soluble amine compound include amines having a pKa (acid dissociation constant) in an aqueous solution at 25° C. of 7.5 to 13. Specific examples include alkanolamines such as monoethanolamine, diethanolamine, triethanolamine, 2-(2-aminoethoxy)ethanol, N,N-dimethyl ethanolamine, N,N-diethyl ethanolamine, N,N-dibutylethanolamine, N-methylethanolamine, N-ethylethanolamine, N-butylethanolamine, N-methyldiethanolamine, monoisopropanolamine, diisopropanolamine, and triisopropanolamine; polyalkylenepolyamines such as diethylene triamine, triethylene tetramine, propylenediamine, N,N-diethylethylene diamine, 1,4-butanediamine, N-ethyl-ethylene diamine, 1,2-propane diamine, 1,3-propane diamine, and 1,6-hexanediamine; aliphatic amines such as 2-ethyl-hexylamine, dioctylamine, tributylamine, tripropylamine, triallylamine, heptylamine, and cyclohexylamine; aromatic amines such as benzylamine, and diphenylamine; cyclic amines such as piperazine, N-methyl-piperazine, and hydroxyethylpiperazine, and the like. Among these, amines having a boiling point of no less than 140° C. (760 mmHg) are preferred, and for example, monoethanolamine, triethanolamine or the like may be preferably used.

The amount of the water soluble amine compound when added is adjusted to preferably about 0.1 to 30% by mass, and particularly preferably about 2 to 15% by mass in the solid content of the coating formation agent.

### Non-Amine Based Water Soluble Organic Solvent

By blending the non-amine based water soluble organic solvent, generation of the defect can be still further suppressed.

Such non-amine based water soluble organic solvents may be any solvent so long as it is a water miscible non-amine organic solvent, for example, sulfoxides such as dimethylsulfoxide and the like; Sulfones such as dimethylsulfone, diethylsulfone, bis(2-hydroxyethyl)sulfone, tetramethylenesulfone, and the like; amides such as N,N-dimethylformamide, N-methylformamide, N,N-dimethylacetamide, N-methylacetamide, N,N-diethylacetamide, and the like; lactams such as N-methyl-2-pyrrolidone, N-ethyl-2-pyrrolidone, N-propyl-2-pyrrolidone, N-hydroxymethyl-2-pyrrolidone, N-hydroxyethyl-2-pyrrolidone, and the like; imidazolidinones such as 1,3-dimethyl-2-imidazolidinone, 1,3-diethyl-2-imidazolidinone, 1,3-diisopropyl-2-imidazolidinone, and the like; polyhydric alcohols such as ethylene glycol, ethylene glycol monomethyl ether, ethylene glycol monoethyl ether, ethylene glycol monobutyl ether, ethylene glycol monomethyl ether acetate, ethylene glycol monoethyl ether acetate, diethylene glycol, diethylene glycol monomethyl ether, diethylene glycol monoethyl ether, diethylene glycol monobutyl ether, propylene glycol, propylene glycol monomethyl ether, glycerin, 1,2-butylene glycol, 1,3-butylene glycol, and 2,3-butylene glycol, and derivatives thereof. Among these, in light of suppression of the generation of the defect, and the like, polyhydric alcohols and derivatives thereof may be preferably used, and particularly glycerin is preferably used. The nonamine based water soluble organic solvent may be used alone, or two or more of them may be used.

The amount of the non-amine based water soluble organic solvent when added is adjusted to preferably about 0.1 to 30% by mass, and particularly preferably about 0.5 to 15% by mass based on the mass of the aforementioned water soluble polymer (a).

The method for forming a micropattern according to the present invention includes steps of: applying the coating formation agent on a substrate having a resist pattern; thereafter allowing the coating formation agent to be shrinked; and then removing the coating formation agent.

Production of the substrate having a resist pattern is not particularly limited, and can be carried out by a common method employed in manufacture of a semiconductor device, liquid crystal display device, magnetic head, microlens, etc. For example, a composition for a chemically amplified photoresist or the like is applied by a spinner etc., on a substrate such as a silicon wafer, followed by drying to form a photoresist layer, and thereafter a photoresist pattern can be formed on the substrate by irradiating an actinic ray such as an ultraviolet ray, deep-UV, or excimer laser beam with a step-and-repeat projection aligner or the like through a desired mask pattern in vacuum or through a liquid having a specified refractive index, or by drawing with an electron beam, followed by heating, and then subjecting to a development process using a development solution such as, for example, an alkaline aqueous solution such as 1 to 10% by mass tetramethylammonium hydroxide (TMAH) aqueous solution, or the like.

The composition for a photoresist used as a material for the resist pattern is not particularly limited, and a photoresist composition widely employed in general such as a photoresist composition for an i, or g ray, a photoresist composition for an excimer laser such as KrF, ArF or F₂, a photoresist composition for EB (electron beam), a photoresist for EUV, or the like can be used.

a. Coating Formation Agent Application Step

Next, the coating formation agent is applied to coat over the entire face of the substrate having a photoresist pattern as a mask pattern. Furthermore, after applying the coating formation agent, the substrate may be pre-baked at a temperature of 80 to 100° C. for 30 to 90 seconds.

The coating process may be carried out according to a common method generally employed in conventional thermal flow process. More specifically, an aqueous solution of the coating formation agent is applied on the substrate by well-known application means, such as, for example, a bar coater process, roll coater process, slit coater process, or spin-coating using a spinner.

b. Heating Treatment Step

Next, a heating treatment is carried out to allow the coating film constituted with a coating formation agent to be shrinked. The shrinking action of the coating film permits widening in width and enlarging of the photoresist pattern in the area being is in contact with the coating film, in an amount corresponding to the shrinkage of the coating film. Thus, the photoresist patterns get close to each other, whereby narrowing of the interval between photoresist patterns can be achieved.

The heating treatment temperature is not particularly limited so long as it is a temperature enabling shrinkage of the coating film constituted with the coating formation agent, and is a temperature sufficient for carrying out the micro-fabrication of patterns, but it is preferred that heating is executed at a temperature not causing thermal flow of the photoresist pattern. The temperature not causing thermal flow of the photoresist pattern indicates a temperature at which change in dimensions of the photoresist pattern (for example, alteration of the dimension due to spontaneous flow and the like) is not caused when the substrate is heated which has only a photoresist pattern formed thereon without any coating film formed with the coating formation agent. The heating treatment at such a temperature enables micropatterns having favorable profile to be even more efficiently formed, and such a heat treatment is extremely effective in enabling minimization of a duty ratio within the wafer face, that is, a dependence of the heat treatment on pattern intervals within the wafer face in particular. In view of the temperature at which thermal flow of various kinds of photoresist compositions used in currently available photolithographic techniques begins, a preferable heating treatment is usually in the range of approximately 80 to 180° C., provided that the temperature does not cause thermal flow of the photoresist for about 30 to 90 seconds.

Furthermore, the coating film constituted with the coating formation agent has a thickness such that the height of the surface thereof almost equals or is over the height of the photoresist pattern.

c. Coating Formation Agent Removing Step

Thereafter, the coating film constituted with the coating formation agent remaining on the substrate having a photoresist pattern is removed by washing with an aqueous solvent, preferably pure water for 10 to 60 seconds. Prior to the removing step by washing with water, rinsing with an alkaline aqueous solution (for example, tetramethylammonium hydroxide (TMAH), choline or the like) may be also carried out when required. The coating formation agent according to the present invention is easily removed by washing with water, and can be removed completely from the substrate and photoresist pattern.

Thus, the substrate having a micro-fabricated pattern defined among the width-wise widened and enlarged photoresist patterns on the substrate is obtained.

The micropattern obtained according to the present invention has a finer micropattern dimension than the resolution limit achieved by conventional methods, has a favorable resist pattern configuration, and has physical properties which can satisfactorily meet the required characteristics as demanded.

The steps a to c described above may be repeated several times. By thus repeating the steps a to c several times, the photoresist pattern can be gradually width-wise widened and enlarged.

Technical field to which the present invention is applied is not limited to the field of semiconductors, and the present invention is applicable broadly for use in manufacture of liquid crystal display elements, magnetic heads, as well as microlenses.

### EXAMPLES

Hereinafter, the present invention is explained in more detail by way of Examples, but the present invention is not in any way limited to these Examples.

### Coating Formation Agent A

With a 4% by mass aqueous solution of polyvinylpyrrolidone was blended 400 ppm of tetramethylammonium hydroxide based on the total mass of polyvinylpyrrolidone to prepare a coating formation agent A.

### Coating Formation Agent B

With a 4% by mass aqueous solution of polyvinylpyrrolidone was blended 600 ppm of tetramethylammonium hydroxide based on the total mass of polyvinylpyrrolidone to prepare a coating formation agent B.

### Coating Formation Agent C

With a 4% by mass aqueous solution of polyvinylpyrrolidone was blended 400 ppm of N,N-dimethylpyrrolidinium based on the total mass of polyvinylpyrrolidone to prepare a coating formation agent C.

### Coating Formation Agent D

A copolymer of acrylic acid/vinylpyrrolidone (AA/VP) with a polymerization ratio of AA:VP being 2:1.3 in an amount of 7.0 g, 6 g of triethylamine, and 1 g of “Plysurf A210G” (manufactured by Dai-ichi Kogyo Seiyaku Co., Ltd.) as a surfactant based on a phosphoric acid ester of polyoxyethylene were dissolved in pure water, and the total mass was adjusted to 100 g to prepare a coating formation agent D.

### Coating Formation Agent E

A 4% by mass aqueous solution of polyvinyl alcohol was prepared as a coating formation agent E.

On the other hand, a positive type photoresist, TARF-P7066 (manufactured by Tokyo Ohka Kogyo Co., Ltd.), was spin-coated on an 8-inch silicon wafer, and baked at 135° C. for 60 seconds to form a photoresist layer having a film thickness of 200 nm.

An exposure process was conducted on the photoresist layer using an exposure apparatus NSR-S203 (manufactured by Nikon Corporation), and then a heating process was carried out at 110° C. for 60 seconds, followed by a development process using a 2.38% by mass aqueous TMAH (tetramethylammonium hydroxide) solution to form a hole pattern with a diameter of 120 nm (hole pattern diameter: distance between hole patterns=1:1).

Next, each of the coating formation agents A to E was applied on a silicon wafer having this resist pattern formed thereon to form a coating film having a film thickness of 200 nm. The wafer was subjected to a heating treatment at 150° C. for 60 seconds to execute a micro-fabrication process of the hole pattern. Subsequently, the coating formation agent was removed using pure water at 23° C.

With respect to these micro-fabrication processes, the following Evaluations 1 to 6 were made, respectively. The results are shown in Table 1.

### Evaluation 1: Generation of Defects

The substrates after the micro-fabrication processes described above were observed with KLA (manufactured by KLA-Tencor Ltd.), and the number of defects was counted. The number of the defects resulting from the micro-fabrication process carried out using the coating formation agent E was assumed as 100%, and the results obtained using other coating formation agent are shown in Table 1, respectively, in terms of the percentage based on this standard.

### Evaluation 2: Variation of the Micro-Fabrication Size Due to Change of Heating Treatment Temperature

The micro-fabrication process as described above was carried out in which the temperature of the heating treatment in the micro-fabrication process was changed to four points of 130° C., 140° C., 150° C. and 160° C. The resist pattern dimension after the micro-fabrication process was measured with a scanning electron microscope. Variation of the micro-fabrication size per ° C. was calculated from the changes in the resulting micro-fabrication size, and shown in Table 1, respectively.

### Evaluation 3: Variation of Micro-Fabrication Size of Sparse/Dense Pattern

The micro-fabrication processes were carried out, respectively, for the pattern in which the distance between the aforementioned hole patterns was predetermined 1 time (the same as), 1.5 times, 2 times and 5 times the hole pattern diameter. The resist pattern obtained after the micro-fabrication process was subjected to determination with a scanning electron microscope, and the differences between the minimum value and the maximum value of the micro-fabrication size are shown in Table 1, respectively.

Evaluation 4: Resist Pattern Configuration after Micro-Fabrication Process

The resist pattern configuration after the micro-fabrication process described above was observed and evaluated with a scanning electron microscope. The results are shown in Table 1, in terms of A indicating that the resist pattern has a favorable rectangular shape, and B indicating that the pattern configuration does not have a rectangular shape.

### Evaluation 5: Micro-Fabrication Size

The resist pattern dimension after the micro-fabrication process described above was determined with a scanning electron microscope. The micro-fabrication size achieved when micro-fabrication was carried out from the initial resist pattern dimension is shown in Table 1, respectively.

### Evaluation 6: Development of Bacteria

The aforementioned coating formation agents were filtered using Millpore MX00 TT220, a filter for aerobic heterotrophic bacteria, before application, and applied on a substrate. The substrate was thereafter left to stand at room temperature for three days, and the development of bacteria was evaluated by visual observation. The results are shown in Table 1, respectively, in terms of A indicating that bacteria were not developed, and B indicating that bacteria were developed.

TABLE 1

| | Evalu- | | Evalu- | Evalu- | Evalu- | Evalu- |
|---|---|---|---|---|---|---|
| | ation 1 | Evaluation 2 | ation 3 | ation 4 | ation 5 | ation 6 |
| Coating | A | 0.2 nm/° C. | 0.2 nm | A | 20.0 nm | A |
| formation | | | | | | |
| agent A | | | | | | |
| Coating | A | 0.2 nm/° C. | 0.2 nm | A | 20.0 nm | A |
| formation | | | | | | |
| agent B | | | | | | |
| Coating | A | 0.2 nm/° C. | 0.2 nm | A | 20.0 nm | A |
| formation | | | | | | |
| agent C | | | | | | |
| Coating | A | 2.0 nm/° C. | 0.2 nm | B | 33.0 nm | A |
| formation | | | | | | |
| agent D | | | | | | |
| Coating | A | 0.2 nm/° C. | 1.0 nm | A | 5.0 nm | B |
| formation | | | | | | |
| agent E | | | | | | |

In the Examples described above, micro-fabrication processes were carried out in an entirely similar manner except that the positive type photoresist was changed to TARF-P7152 (manufactured by Tokyo Ohka Kogyo Co., Ltd.), and similar evaluations to the aforementioned Evaluations 1 to 6 were conducted. The results are shown in Table 2.

TABLE 2

| | Evalu- | | Evalu- | Evalu- | Evalu- | Evalu- |
|---|---|---|---|---|---|---|
| | ation 1 | Evaluation 2 | ation 3 | ation 4 | ation 5 | ation 6 |
| Coating | A | 0.2 nm/° C. | 0.2 nm | A | 16.0 nm | A |
| formation | | | | | | |
| agent A | | | | | | |
| Coating | A | 0.2 nm/° C. | 0.2 nm | A | 16.0 nm | A |
| formation | | | | | | |
| agent B | | | | | | |
| Coating | A | 0.2 nm/° C. | 0.2 nm | A | 16.0 nm | A |
| formation | | | | | | |
| agent C | | | | | | |
| Coating | Micro-fabrication size: zero | | | | | |
| formation | | | | | | |
| agent D | | | | | | |
| Coating | A | 0.2 nm/° C. | 1.0 nm | A | 5.0 nm | B |
| formation | | | | | | |
| agent E | | | | | | |

1. A coating formation agent for pattern micro-fabrication used for forming a micropattern by coating on a substrate having a photoresist pattern,
the coating formation agent comprising: as component (a), a water soluble polymer; and, as component (b), at least one selected from quaternary ammonium hydroxide, alicyclic ammonium hydroxide and morpholinium hydroxide.

2. The coating formation agent for pattern micro-fabrication according to claim 1, wherein the component (a) is a polymer or a copolymer, or a mixed polymer thereof constituted with at least one monomer selected from acrylic acid, methyl acrylate, methacrylic acid, N,N-dimethylacrylamide, N,N-dimethylaminopropylmethacrylamide, N,N-dimethylaminopropylacrylamide, N-methylacrylamide, diacetoneacrylamide, N,N-dimethylaminoethyl methacrylate, N,N-diethylaminoethyl methacrylate, N,N-dimethylaminoethyl acrylate, N-acryloylmorpholine, N-vinylpyrrolidone, vinyl acetate, and N-vinylimidazolidinone.

3. The coating formation agent for pattern micro-fabrication according to claim 1, wherein the component (a) is a polymer and/or a copolymer of at least one monomer selected from N-vinylpyrrolidone and vinyl acetate.

4. The coating formation agent for pattern micro-fabrication according to claim 1, wherein the component (a) is polyvinylpyrrolidone.

5. The coating formation agent for pattern micro-fabrication according to claim 1, wherein the component (a) is a water soluble polymer having a mass-average molecular weight of 50,000 to 300,000.

6. The coating formation agent for pattern micro-fabrication according to claim 1, wherein the component (b) is a quaternary ammonium hydroxide.

7. The coating formation agent for pattern micro-fabrication according to claim 1, which is an aqueous solution having a solid content concentration of 1 to 50% by mass.

8. The coating formation agent for pattern micro-fabrication according to claim 1, which comprises 0.001 to 3 parts by mass of the component (b) based on 100 parts by mass of the component (a).

9. The coating formation agent for pattern micro-fabrication according to claim 1, which comprises 0.01 to 1 part by mass of the component (b) based on 100 parts by mass of the component (a).

10. A method for forming a micropattern, comprising: applying the coating formation agent for pattern micro-fabrication according to claim 1 on a substrate having a photoresist pattern; thereafter allowing the coating formation agent for pattern micro-fabrication to be thermally shrinked by a heating treatment; and then removing the coating formation agent for pattern micro-fabrication.

11. The method for forming a micropattern according to claim 10, wherein the heating treatment is carried out at a temperature not causing thermal flow of the photoresist pattern on the substrate.
